(19) United States
(12) Patent Application Publication
(10) Pub. No.: US 2023/0144553 A1
(43) Pub. Date: May 11, 2023

(54) SOFTWARE-DIRECTED REGISTER FILE SHARING

(71) Applicant: NVIDIA Corp., Santa Clara, CA (US)

(72) Inventors: Sana Damani, Atlanta, GA (US); Sean Treichler, Piedmont, CA (US); Mark Stephenson, Austin, TX (US)

(21) Appl. No.: 17/697,325

(22) Filed: Mar. 17, 2022

Related U.S. Application Data
(60) Provisional application No. 63/253,787, filed on Oct. 8, 2021.

(51) Int. Cl. G06F 9/30; G06F 9/32; G06F 9/48

(52) U.S. Cl. CPC G06F 9/30098; G06F 9/321; G06F 9/3009; G06F 9/4881; G06F 9/30065

(57) ABSTRACT

A computing system including one or more processor and one or more memory that stores application code that configures the processor to execute an application. The system includes logic to identify high and low register utilization regions of the application code and insert register acquire instructions and register release instructions in the application code by the compiler, such that when executed by the processor, the application code borrows and returns registers to an inter-block register pool when execution enters a high and low register utilization region, respectively.

### CROSS REFERENCE TO RELATED APPLICATIONS

This application claims priority and benefit under 35 U.S.C. 119(e) to U.S. Application Serial No. 63/253,787, titled “Software-directed register file sharing”, filed on Oct. 8, 2021, the contents of which are incorporated herein by reference in their entirety.

### BACKGROUND

Some types of processors such as graphics processing units (GPUs) execute groups of threads called warps in a Single Instruction Multiple Thread (SIMT) manner, in which multiple threads in a warp (see definition below) execute the same instruction in parallel.

When individual threads take divergent execution paths, parallel execution is no longer possible, and the divergent paths are serialized, temporarily, for execution. This is referred to as thread divergence, the condition in which the next instruction to execute in a first thread is at a different program counter location than the next instruction to execute in a second thread.

Computer applications, particularly some graphics applications, may execute as multiple divergent shards (see definition below). For example, in ray tracing applications, when a ray encounters a surface, it may trigger a shader that processes the interaction between the ray and the surface, which may result in the generation of additional (e.g., reflected) rays. Different rays may trigger different shaders. These actions can cause thread divergence, which can lead to low warp occupancy, and register utilization may vary greatly among the divergent execution paths. Ray tracing applications are typically sensitive to computational performance and are thus an example of applications that may experience high thread divergence, latency sensitivity, wide variation in register utilization, and low warp occupancy.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an example of divergent execution of shader code blocks (shards) during ray tracing.

FIG. 2 depicts shard divergence 200 in accordance with one embodiment.

FIG. 3A depicts an example of register usage by shader code blocks.

FIG. 3B depicts an example of conditional fast and slow branch execution by shader code blocks.

FIG. 4 a register file configuration in accordance with one embodiment.

FIG. 5 depicts a register state machine in accordance with one embodiment.

FIG. 6 depicts a parallel processing unit 602 in accordance with one embodiment.

FIG. 7 depicts a general processing cluster 700 in accordance with one embodiment.

FIG. 8 depicts a memory partition unit 800 in accordance with one embodiment.

FIG. 9 depicts a streaming multiprocessor 900 in accordance with one embodiment.

FIG. 10 depicts a processing system 1000 in accordance with one embodiment.

FIG. 11 depicts an exemplary processing system 1100 in accordance with another embodiment.

FIG. 12 depicts a graphics processing pipeline 1200 in accordance with one embodiment.

FIG. 13 depicts a computing platform 1302 in accordance with one embodiment.

### DETAILED DESCRIPTION

The following description may be better understood with reference to certain terms as defined below. Other terms should be accorded their convention meaning in the art.

“Application” refers to any executable software instructions stored in machine memory and executed by one or more computer processors.

“Application code” refers to the instructions of an application.

“Divergent thread” refers to a thread that has reached a program counter during execution that is different than the program counter reached in a parallel executing thread. The two threads are then said to be divergent or diverged.

“Free register pool” refers to a set of registers that are not allocated to any thread at a particular moment during execution of application code, and which are not reserved for allocation by threads in particular thread blocks or inter-block register pools. In one embodiment, the free register pool may be used to provide register allocations for newly-launched thread blocks, but not for threads to acquire/release registers during execution. In other embodiments, the free register pool may be available in both circumstances and may prioritize the acquiring of registers during execution over allocation of registers at the launch of a new thread block (or vice versa).

“Hardware scheduler” refers to hardware logic configured (e.g., via microcoding or circuitry arrangement) to implement a thread and/or thread group scheduling algorithm.

“Inter-block register pool” refers to a register pool reserved for use by threads of multiple thread blocks. An inter-block register pool is distinguished from the free register pool in that the registers reserved for the inter-block register pool are available for allocation only by threads of the thread blocks configured to belong to the inter-block register pool.

“Intra-block register pool” refers to a register pool reserved for use by threads of a specific thread block.

“Mega-kernel” herein refers to logic that may execute as multiple divergent threads by generating threads utilizing the same instructions with different data that triggers thread divergence at conditional statements.

“Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Shader module” refers to shader logic (many varieties of which are known in the art) implemented as a module, which is logic having configured invocation interfaces such that the module may be invoked as a unit using those interfaces (e.g., by passing operands to those interfaces).

“Shard” refers to a subset of one or more threads in a warp that are fully converged, e.g., that have not diverged and thus all execute the same instruction program counter in parallel.

“SIMD” refers to Single Instruction, Multiple thread, a type of instruction execution architecture. In a SIMD architecture, each instruction applies the same operation in parallel across data elements organized in a vector. SIMD is typically implemented using processors with vector registers and execution units; a scalar thread issues vector instructions that execute in SIMD fashion on each data element of the associated vectors.

“SIMT” refers to Single Instruction, Multiple Thread, a type of instruction execution architecture. In a SIMT architecture, rather than a single thread issuing vector instructions that are applied to data vectors, multiple threads issue common instructions to unstructured (not formed into vectors) data. A SIMT architecture enables each thread to access its own registers, to load and store data from divergent addresses, and to follow divergent control flow paths. The compiler and the processor (e.g., a GPU) work together to ensure the threads of a warp execute the same instruction sequences together as frequently as possible to maximize performance. This is known as improving or optimizing thread convergence.

“Software scheduler” refers to non-transitory software logic configured to implement a thread and/or thread group scheduling algorithm.

“Thread” refers to an atomic unit of execution from a scheduling perspective. In other words, a thread is the most basic unit of execution parallelism on a data processing architecture. Threads may be grouped into larger units of parallelism, such as warps, blocks, and grids, for example on Nvidia architectures.

“Thread block” an application execution control structure comprising a group of threads that may execute serially or in parallel. For improved process and data mapping, execution threads may be grouped into thread blocks. Threads in the same block are enabled with certain capabilities not available to threads outside the thread block, such as the ability to communicate with each other via shared memory, and to coordinate execution via barrier synchronization or other synchronization primitives such as atomic operations. A thread block is composed of warps.

Once a thread block is launched on a multiprocessor (SM), all of its warps are resident until their execution finishes. Thus a new block is not launched on an SM until there is sufficient number of free registers for all warps of the new block, and until there is enough free shared memory for the new block.

“Thread convergence” refers to the process of converging multiple threads to a common program counter location in a code section. One conventional approach to causing thread convergence is the use of the __syncthreads() instruction. Synchronization points in code can be specified by invoking __syncthreads() which acts as a barrier at which all threads in some defined group (e.g., in a warp) must wait for all in the group to arrive at, before any thread of the group is allowed to continue execution. Once the last thread of the group arrives at the barrier location, all the threads in the group continue executing more or less in parallel from that point in the code, and may gradually diverge again (thread divergence) due to differences in the data they process leading to different execution branches. Eventually, the threads may reach another barrier, and wait there to converge again.

“Thread divergence” refers to the condition in which the next instruction to execute in a first thread is at a different program counter location than the next instruction to execute in a second thread.

“Warp” refers to a set of threads grouped to undergo execution together on a processor, for example on a GPU. For example a warp may comprise thirty-two threads of an application, each thread tracing out a single ray. A warp is a set of threads within a thread block such that all the threads (when converged) in a warp execute the same instruction (are aligned on the same instruction pointer), but typically on different operand values.

“Warp occupancy” refers to the ratio of a number of actively executing warps to a total number of active warps that a streaming mulitprocessor is configured to support.

“Warp sharding” refers to executing a warp of threads in a plurality of groups of parallel executing threads, called shards.

“Workload” refers to code that is applied for execution by multiple threads.

Some conventional approaches to register file management in SIMT applications implement early register release via a compiler-directed approach to identify and release unused registers back to the register pool at the end of their lifetime so that new warps may be launched, thereby increasing occupancy. These approaches however do not take into account the problem of low register utilization in the beginning or middle of program execution and cannot reacquire registers once released.

Other conventional approaches seek to reduce the physical register file size, and hence chip area, without loss of occupancy by sharing registers across warps. These approaches do not address the problem of inefficient register usage within warps that lead to low warp occupancy.

Embodiments of hybrid hardware and software mechanisms are disclosed herein to address resource allocation inefficiencies on SIMT computing platforms such as those utilizing GPUs. Multiple resources limit parallelism on such platforms, including warp slots, registers and shared memory. If one of these resources is exhausted but other resources are available, the exhausted resource becomes a limiter. One embodiment addresses the problem of register-limited applications that exhibit low warp occupancy despite warp slot availability. In particular, certain application programs benefit from a larger effective register file size and exhibit high variation in register usage during their lifetimes. For example in several ray tracing applications, warps may be launched with an allocation of a maximum number of registers that the warp may use during its lifetime. However, most of the execution time of the warp may be spent in low register utilization blocks of code.

With register limited applications, the number of warps that may concurrently execute is limited by register usage. This can lead to situations in which there are insufficient concurrent warps to hide pipeline stalls by switching execution to other warps from stalled warps. However during execution, a particular warp for certain kinds of applications (e.g., ray tracing) may exhibit wide variation in the extent of register usage at various times, resulting in periods of high and low resource utilization.

To address these issues, embodiments of logic are disclosed to identify high and low register resource utilization regions within an application and share registers across warps of the application, instead of configuring the warps with static, maximum register allocations. Warps can, via software mechanisms, acquire and release registers dynamically. This dynamic flexibility enables an increase in warp occupancy without a commensurate increase in register file size (which is expensive).

One example of applications that may benefit from the disclosed mechanisms are ray tracing applications. Ray tracing applications tend to be register-limited and have high variation in register usage during execution. Register file sharing among warps of ray tracing applications may increase warp occupancy through the dynamic acquiring and releasing of registers by warps. Deadlock may be avoided and performance enhanced using slow path compilation and slow path avoidance schemes.

One aspect involves compiler-guided identification of high and low utilization regions of application code and the insertion of “register acquire” and “register release” instructions in the code by the compiler. While register acquire instructions may fail, register release instructions may always succeed. For example a GPU may launch warps with fewer initial registers than the maximum needed to increase overall warp occupancy, thereby reducing program execution time. The launched warps then borrow and return registers to an inter-block register pool when they enter a high or low register utilization region, respectively. This increases the effective register file size and warp occupancy without increasing the size of the physical register file.

To guarantee forward progress, the compiler may generate a “slow” execution version of the code that employs register spill and refill instructions to use fewer registers when an acquire attempt fails.

A tool such as a software compiler may automate the insertion of acquire and release instructions in application code. In some cases these may also be inserted manually by a software developer. A compiler may identify strategic locations within programs to acquire or release registers. These locations, as well as the identity of sets of registers to acquire/release, may be determined from static (code not executing) analysis or runtime profile information.

The presence of these instructions raises the possibility that the warp may deadlock waiting to acquire registers needed for forward execution progress. In particular, this can happen if all warps in some group are waiting to acquire and none of them releases register resources. To help avoid deadlocks, the compiler may insert into the program a code block for conditional slower execution that utilizes fewer registers and inserts spill and refill instructions to account for the high register pressure. The slow path ensures (slower) forward progress even if all other executing or waiting warps are trying to acquire and none succeeds in acquiring registers.

if (!try_acquire())
// slow path
else
// fast path

The compiler may determine a more optimized register launch target (e.g., based on slow path register requirements), different from the maximum register count available, to balance the increase in occupancy with the increased overhead incurred by slow path execution. The compiler may identify and configure a minimum register target below which the application shall not release registers. This minimum target helps ensure that the program always has the minimum number of registers to execute at least the slow path with forward progress guarantees.

The compiler may additionally (e.g., optionally) take steps to reduce the number of warps that wind up taking slow path execution. For example, the compiler may insert a back-off loop that re-attempts to acquire registers if (on condition that) the register pool is empty. This may be particularly useful when entering critical paths of the code where spill/refill instructions may hurt performance. For example:

retry_attempts = N
while (retry_attempts > 0 && !try_acquire())
retry_attempts--
if (retry_attempts == 0)
// slow path
else
// fast path

The compiler may also prioritize branch target selection at multi-path divergent branches to select the optimum branch target code block based on dynamic register pool size to minimize slow path execution.

In some embodiments, the warp scheduler (which may be a hardware scheduler or a software scheduler, or a combination thereof) may be adapted with logic to select for execution a warp whose resource requirements can be met by the present state of the register pools. That is, if a warp fails to acquire, another warp may take its place.

One embodiment may enable “partial acquisitions”. Instead of an all-or-nothing approach to register acquisition, the compiler may configure the application code with a spectrum of slow execution paths. In the event that some but not all of the registers are available to execute the “fast path” (the path executed when additional register resources are successfully obtained by the register acquire instructions), the code may branch to a path (from among several available) that fits the number of registers available to acquire. Known compiler transformations such as code hoisting, register rematerialization and instruction scheduling may reduce the cost (latency and/or instruction count) of slow path execution.

In some embodiments hardware logic may be implemented to repurpose registers within a thread block. For example certain GPUs provided by Nvidia® include an instruction called USETMAXREG for releasing, deallocating, and allocating registers. The executing code may set the number of registers it needs at given points in the instruction stream. Warps that are currently using more registers than specified by the instruction deallocate to a thread-block wide register pool (intra-block register pool), or release to a free pool, to launch additional thread blocks. Warps that are currently using fewer registers than specified in the instruction try to acquire additional registers from the intra-block register pool. To increase the efficiency of the application, for example in executing ray tracing applications (which tend to have very small thread blocks e.g., only two warps), a third, inter-block register pool may be implemented. Multiple thread blocks belonging to this pool may borrow from and return registers to it, thereby enabling register sharing between all thread blocks belonging to the inter-block register pool.

To implement these mechanism, a system that includes a processor and a memory comprising application code that configures the processor to execute an application generates register acquire instructions and register release instructions in the application code. When executed by the (one or more) processor, the application code borrows and returns registers to an inter-block register pool when execution enters a particular section of the application code. The system may generate, in the application code, a slow execution path that employs register spill and refill instructions to be executed only on condition that the register acquire instructions fail. In some embodiments, the system may generate, in the application code, a plurality of slow execution paths that each implement a different extent of register spill and refill and thus different execution efficiencies.

Register utilization in sections of the application code may be determined using one or both of static analysis and runtime profile analysis of the application code. A minimum register allocation amount (target) may be configured for the application code below which the application code is configured to not release registers.

The system may generate, in the application code, a back-off loop that re-attempts the register acquire instructions on condition that the inter-block register pool is empty or fails to satisfy a configured threshold level.

To enable greater flexibility and efficiency in register resource utilization, the system may include a free register pool, an intra-block register pool, an inter-block register pool, where some of the register acquire instructions and register release instructions in the application code are configured to borrow registers from and return registers to the intra-block register pool exclusively, and some of the register acquire instructions and register release instructions in the application code are configured to borrow from and return registers to the inter-block register pool exclusively.

Corresponding methods for such systems, and other technical features of the system, may be readily apparent to one skilled in the art from the following figures, descriptions, and claims. In view of this disclosure, implementation of the described register resource management mechanisms on specific computing platforms and execution pipeline architectures will be readily apparent to those of ordinary skill in the art without undo experimentation.

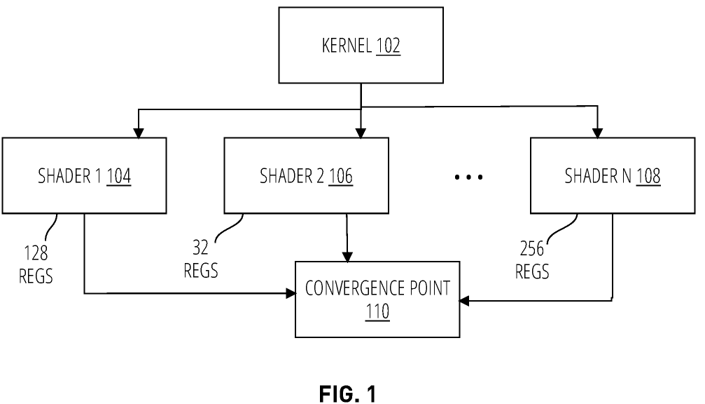

FIG. 1 depicts an example of execution flow in application code for shading a computer-generated scene, e.g. using ray tracing. The execution flow comprises a kernel 102 that executes as a number N of shading algorithms (e.g., for different rays) in divergent shards. These shaders are depicted by shader 1 104, shader 2 106, up to a shader N 108. The execution of the shards of the kernel 102 reconverge at a convergence point 110.

Each shader requires a different maximum number of registers during execution. Shader 1 104 for example requires up to 128 registers, shader N 108 requires up to 256 registers, whereas shader 2 106 only utilizes a maximum of 32 registers.

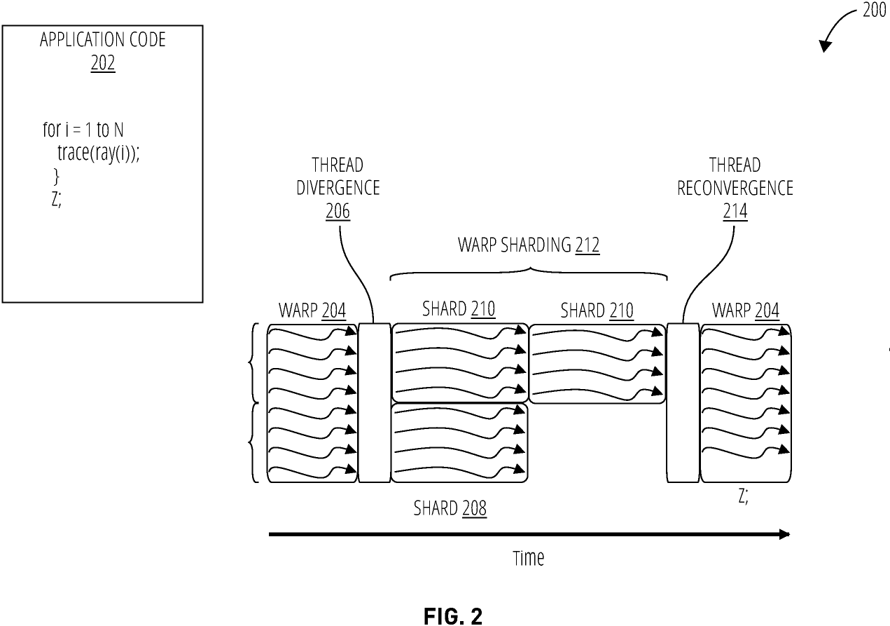

FIG. 2 depicts shard divergence 200 in one embodiment. SIMT execution of an application in a warp executes the same instruction of the threads in parallel. This causes execution of the warp to split into shards and serialize when a divergence point is reached in the application. Execution reconverges at some later point when the threads have an instruction in common.

In the shard divergence 200 example, the application code 202 includes a divergent branch dependent on thread-local values (the value of the thread id, threadldx.x). The warp 204 for the application code 202 splits into divergent threads at the condition evaluation, resulting in thread divergence 206 into a first shard 208 of four threads executing instructions A and B, and a second shard 210 of a different set of four threads executing instructions X and Y. The serialized execution of the shard 208 and the shard 210 is referred to as warp sharding 212. Thread reconvergence 214 of the warp 204 occurs at instruction Z, warp sharding 212 ceases, and threads of the warp 204 execute again in parallel.

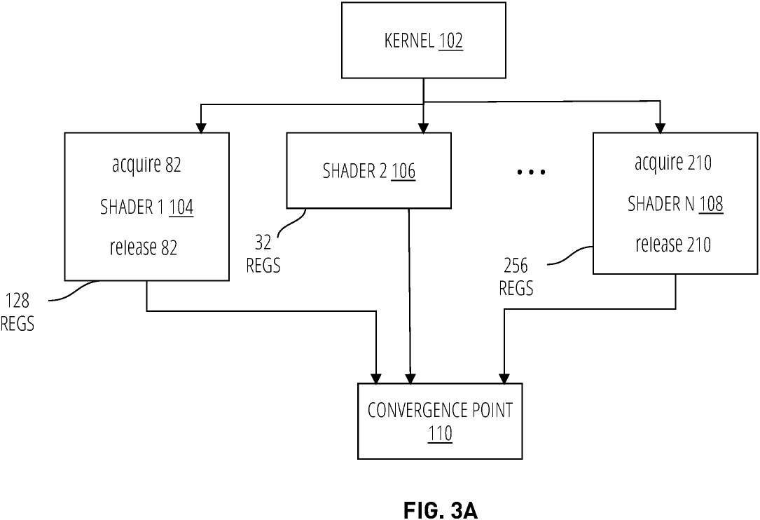

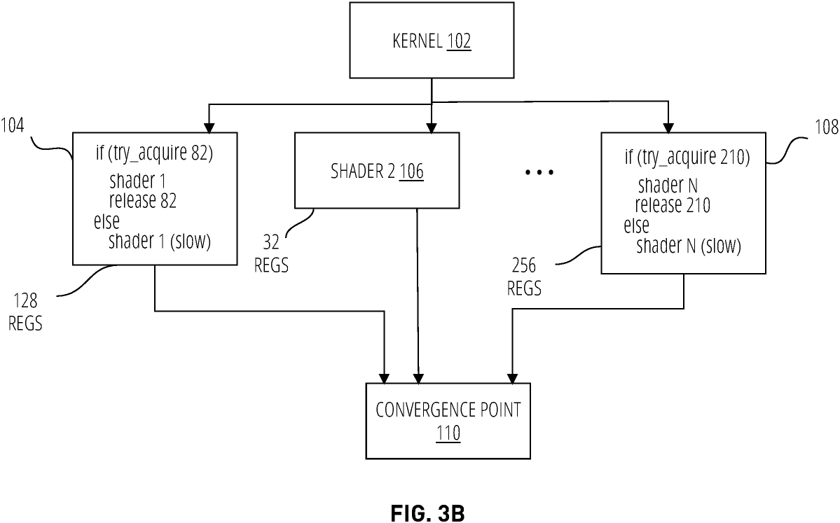

FIG. 3A depicts an example use of register acquire instructions and register release instructions. The shader 1 104 needs a maximum of 128 registers, but during much of its execution, uses only 128-82 = 46 registers. Thus, shader 1 104 is launched with only 46 registers allocated. When shader 1 104 reaches a point in its execution requiring all 128 registers, it issues a register acquire instruction to obtain another 82 registers. When this register-intensive code block completes, the shader 1 104 issues a register release instruction to return to 82 registers to the free register pool (or, to the inter-block register pool). Likewise, the shader N 108 needs a maximum of 256 registers, but only in a register-intensive code block. The shader N 108 is thus launched with an allocation of only 46 registers, but acquires another 210 registers (from the free register pool or inter-block register pool) during the register-intensive code block. These are released once the register-intensive code block concludes execution. The shader 2 106 only needs a maximum of 32 registers and does not acquire or release registers in this example.

The overall application launched (was initialized for execution) with an allocation of 46 registers, and in fact shader 2 106 could release registers (needing only 32 to execute), but because 46 is a compiler-specified minimum register count, a release of registers is not issued.

As depicted in FIG. 3B, to prevent deadlock when registers are available to be acquired, the shaders may attempt to acquire the extra registers for their register-intensive blocks, but if this fails, they may enter a slower execution path that utilizes fewer registers at the cost of execution performance.

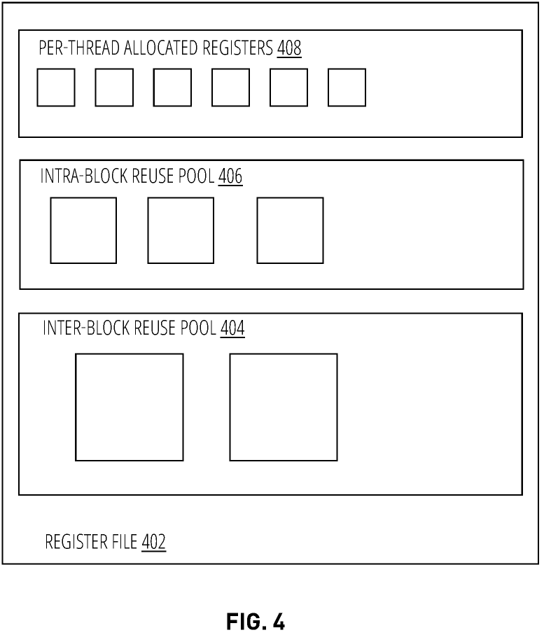

FIG. 4 depicts a register file organization in one embodiment. Within the physical register file 402, some registers are allocated to particular threads (per-thread allocated registers 408). Some sets of registers are not allocated but are reserved for use by threads within particular thread blocks (intra-block reuse pool 406). Some sets of registers are reserved for sharing between thread blocks (inter-block reuse pool 404). Threads not in any of these allocations or reservations are “free” and available for use by any thread that needs them.

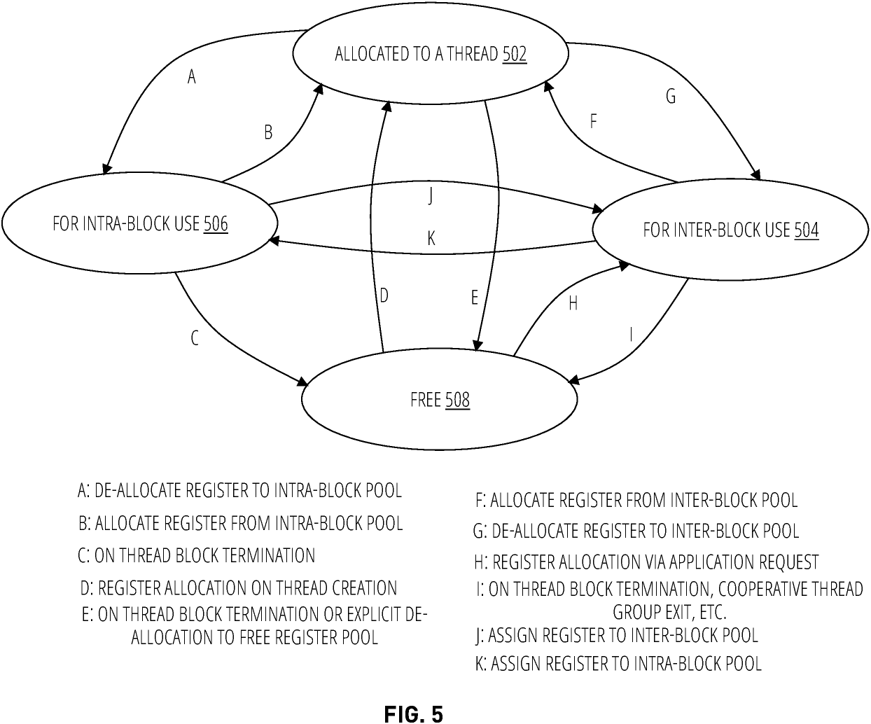

FIG. 5 depicts a register state transition diagram for a register in one embodiment. The register may be in a free state 508, an allocated state 502, an inter-block reserved state 504, or an intra-block reserved state 506, and may transition between these states as a result of certain actions by or on behalf of threads. Although depicted as states for a single register, it should be understood that the states and transitions between them may be applied to groups of registers. Further, a register may be associated with a particular one of multiple inter-block reuse pools 404 and/or intra-block reuse pools 406, as depicted in the example register file 402 configuration of FIG. 4.

A thread can effectively change the state of a register from the intra-block reserved state 506 to the inter-block reserved state 504, or vice-versa, by allocating the register from one state and releasing it to the other. Likewise a thread may allocate a register from the free state 508 and release the register to either the intra-block reserved state 506 or the inter-block reserved state 504. In some embodiments, an instruction or instructions may be implemented to directly change the state of a register from the inter-block reserved state 504 to the intra-block reserved state 506, and/or vice-versa.

For example, when a thread or warp is releasing allocated state 502 registers acquired from any one of the free state 508, inter-block reserved state 504, or intra-block reserved state 506, it may check the status of other threads or warps in its thread block to determine whether or not they need additional registers. If not, the thread or warp may issue an inter-block release instruction for the allocated state 502 registers, placing them into the inter-block reserved state 504. Otherwise the thread or warp may issue an intra-block release instruction to place the allocated state 502 registers into the intra-block reserved state 506.

By way of example the state transitions A, B, and C (allocate and release to/from the intra-block reserved state 506, and release to free state 508) indicated in FIG. 5 may be implemented in one embodiment by the following instructions, respectively:

{@{!}UPg} USETMAXREG.TRY_ALLOC.CTAPOOL UPu, URb
{@{!}UPg} USETMAXREG.TRY_ALLOC.CTAPOOLUPu, #1mmU10
{@{!}UPg} USETMAXREG.DEALLOC.CTAPOOL URb
{@{!}UPg} USETMAXREG.DEALLOC.CTAPOOL #1mmU10
{@{!}UPg} USETMAXREG.RELEASE.FREEPOOL URb
{@{!}UPg} USETMAXREG.RELEASE.FREEPOOL #1mmU10

where:

{! }UPg: Guard Uniform Predicate
.TRY_ALLOC: Register management mode
.CTAPOOL:
.CTAPOOL - register resource pool belonging to a thread block.
.DEALLOC: Register management mode
UPu: Destination Uniform Predicate
.RELEASE: Register management mode
.FREEPOOL: resource pool for new warp launches.
URb: Source B uniform register
#immU10: 10-bit immediate that specifies the new maximum register count for the warp.

In one example, USETMAXREG sets the maximum number of registers to the value specified by either source uniform register URb or the 10-bit immediate #immU10. In one embodiment, the value may be between 8 and 256, inclusive, and may be a multiple of 8. The value specified may be rounded up to an IMPLEMENTATION_DEFINED granularity. USETMAXREG may be executed on divergent threads to release/acquire registers for the threads in a warp. When .DEALLOC is specified, .CTAPOOL (for the intra-block register pool) or .GRIDPOOL (for the inter-block register pool) may be specified, and tail registers move from the warp owner to the respective pool. When .TRY_ALLOC is specified, .CTAPOOL or .GRIDPOOL, and UPu should also be specified, and the allocation may fail or succeed. On failure, e.g. if not enough registers are available in the specified pool, UPu may be written with 0 (zero) and the instruction completes immediately. On success, UPu may be written with 1 (one), and the warp may be enabled to use more registers. When .RELEASE is specified, .FREEPOOL should also be specified, and tail registers move from warp owned to the free pool, where they may be used for new warp launches. In all cases of success, the warp’s count of registers may be updated for handling register out of range checks.

Table 1 depicts example software instructions that warps may issue to dynamically (during execution) manage register allocations:

TABLE 1

| | |
|---|---|
| Register State Transition (see FIG. 5 ) | Command |
| A | USETMAXREG.DEALLOC.CTAPOOL |
| B | USETMAXREG.TRY_ALLOC.CTAPOOL |
| E | USETMAXREG.RELEASE.FREEPOOL |
| F | USETMAXREG.TRY_ALLOC.GRIDPOOL |
| G | USETMAXREG.DEALLOC.GRIDPOOL |

Table 2 depicts logic that may be utilized to implement aspects of the register management techniques described herein, in one embodiment.

TABLE 2

| Register | Thread | Thread block | Status |
|---|---|---|---|
| R1 | 146 | 4 | 1 |
| R4 | 155 | 3 | 0 |

Here a status value of “1” indicates the register is allocated. A status or thread value of “0” indicates the register is not allocated. A value of “0” in the thread block field indicates the register is not reserved for a particular thread block.

Table 3 depicts logic that may be utilized to implement aspects of the register management techniques described herein, in another embodiment.

The mechanisms disclosed herein may be implemented in computing devices utilizing one or more graphic processing unit (GPU) and/or general purpose data processor (e.g., a ‘central processing unit or CPU). Exemplary architectures will now be described that may be configured to carry out the techniques disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

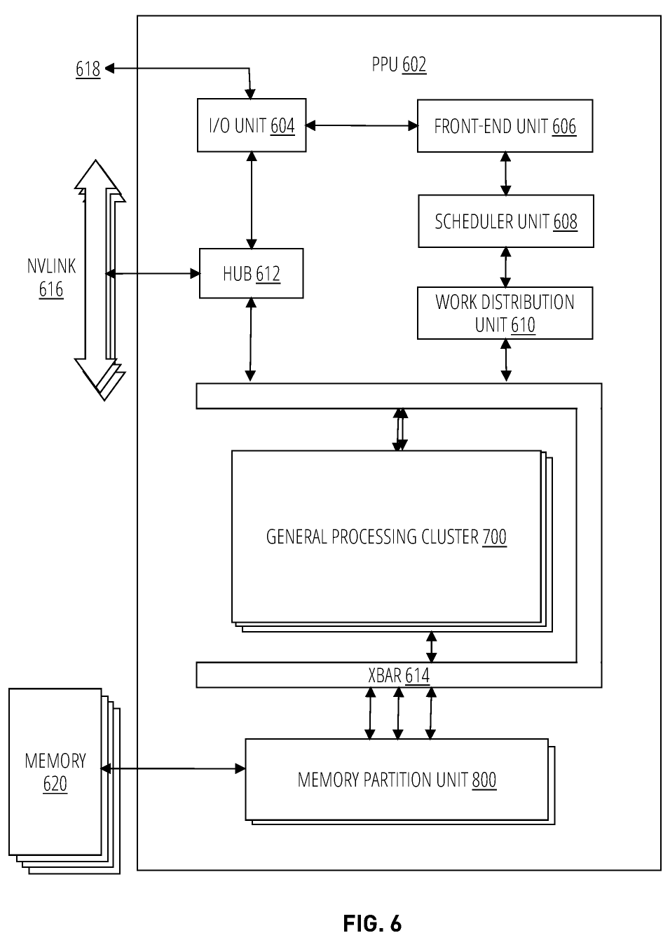

FIG. 6 depicts a parallel processing unit 602, in accordance with an embodiment. In an embodiment, the parallel processing unit 602 is a multi-threaded processor that is implemented on one or more integrated circuit devices. The parallel processing unit 602 is a latency hiding architecture designed to process many threads in parallel. A thread (e.g., a thread of execution) is an instantiation of a set of instructions configured to be executed by the parallel processing unit 602. In an embodiment, the parallel processing unit 602 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 602 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 602 modules may be configured to accelerate thousands of High Performance Computing (HPC), data center, and machine learning applications. The parallel processing unit 602 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 6, the parallel processing unit 602 includes an I/O unit 604, a front-end unit 606, a scheduler unit 608, a work distribution unit 610, a hub 612, a crossbar 614, one or more general processing cluster 700 modules, and one or more memory partition unit 800 modules. The parallel processing unit 602 may be connected to a host processor or other parallel processing unit 602 modules via one or more high-speed NVLink 616 interconnects. The parallel processing unit 602 may be connected to a host processor or other peripheral devices via an interconnect 618. The parallel processing unit 602 may also be connected to a local memory comprising a number of memory 620 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 620 may comprise logic to configure the parallel processing unit 602 to carry out aspects of the techniques disclosed herein.

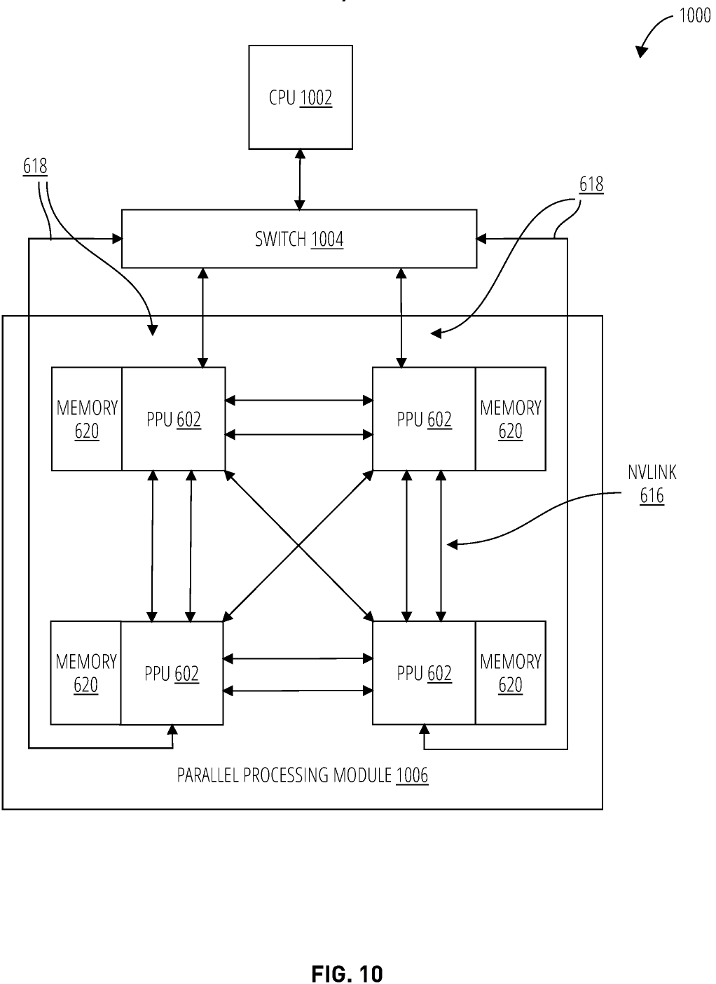

The NVLink 616 interconnect enables systems to scale and include one or more parallel processing unit 602 modules combined with one or more CPUs, supports cache coherence between the parallel processing unit 602 modules and CPUs, and CPU mastering. Data and/or commands may be transmitted by the NVLink 616 through the hub 612 to/from other units of the parallel processing unit 602 such as one or more copy engines, a video encoder, a video decoder, a power management unit, etc. (not explicitly shown). The NVLink 616 is described in more detail in conjunction with FIG. 10.

The I/O unit 604 is configured to transmit and receive communications (e.g., commands, data, etc.) from a host processor (not shown) over the interconnect 618. The I/O unit 604 may communicate with the host processor directly via the interconnect 618 or through one or more intermediate devices such as a memory bridge. In an embodiment, the I/O unit 604 may communicate with one or more other processors, such as one or more parallel processing unit 602 modules via the interconnect 618. In an embodiment, the I/O unit 604 implements a Peripheral Component Interconnect Express (PCIe) interface for communications over a PCIe bus and the interconnect 618 is a PCIe bus. In alternative embodiments, the I/O unit 604 may implement other types of well-known interfaces for communicating with external devices.

The I/O unit 604 decodes packets received via the interconnect 618. In an embodiment, the packets represent commands configured to cause the parallel processing unit 602 to perform various operations. The I/O unit 604 transmits the decoded commands to various other units of the parallel processing unit 602 as the commands may specify. For example, some commands may be transmitted to the front-end unit 606. Other commands may be transmitted to the hub 612 or other units of the parallel processing unit 602 such as one or more copy engines, a video encoder, a video decoder, a power management unit, etc. (not explicitly shown). In other words, the I/O unit 604 is configured to route communications between and among the various logical units of the parallel processing unit 602.

In an embodiment, a program executed by the host processor encodes a command stream in a buffer that provides workloads to the parallel processing unit 602 for processing. A workload may comprise several instructions and data to be processed by those instructions. The buffer is a region in a memory that is accessible (e.g., read/write) by both the host processor and the parallel processing unit 602. For example, the I/O unit 604 may be configured to access the buffer in a system memory connected to the interconnect 618 via memory requests transmitted over the interconnect 618. In an embodiment, the host processor writes the command stream to the buffer and then transmits a pointer to the start of the command stream to the parallel processing unit 602. The front-end unit 606 receives pointers to one or more command streams. The front-end unit 606 manages the one or more streams, reading commands from the streams and forwarding commands to the various units of the parallel processing unit 602.

The front-end unit 606 is coupled to a scheduler unit 608 that configures the various general processing cluster 700 modules to process tasks defined by the one or more streams. The scheduler unit 608 is configured to track state information related to the various tasks managed by the scheduler unit 608. The state may indicate which general processing cluster 700 a task is assigned to, whether the task is active or inactive, a priority level associated with the task, and so forth. The scheduler unit 608 manages the execution of a plurality of tasks on the one or more general processing cluster 700 modules.

The scheduler unit 608 is coupled to a work distribution unit 610 that is configured to dispatch tasks for execution on the general processing cluster 700 modules. The work distribution unit 610 may track a number of scheduled tasks received from the scheduler unit 608. In an embodiment, the work distribution unit 610 manages a pending task pool and an active task pool for each of the general processing cluster 700 modules. The pending task pool may comprise a number of slots (e.g., 32 slots) that contain tasks assigned to be processed by a particular general processing cluster 700. The active task pool may comprise a number of slots (e.g., 4 slots) for tasks that are actively being processed by the general processing cluster 700 modules. As a general processing cluster 700 finishes the execution of a task, that task is evicted from the active task pool for the general processing cluster 700 and one of the other tasks from the pending task pool is selected and scheduled for execution on the general processing cluster 700. If an active task has been idle on the general processing cluster 700, such as while waiting for a data dependency to be resolved, then the active task may be evicted from the general processing cluster 700 and returned to the pending task pool while another task in the pending task pool is selected and scheduled for execution on the general processing cluster 700.

The work distribution unit 610 communicates with the one or more general processing cluster 700 modules via crossbar 614. The crossbar 614 is an interconnect network that couples many of the units of the parallel processing unit 602 to other units of the parallel processing unit 602. For example, the crossbar 614 may be configured to couple the work distribution unit 610 to a particular general processing cluster 700. Although not shown explicitly, one or more other units of the parallel processing unit 602 may also be connected to the crossbar 614 via the hub 612.

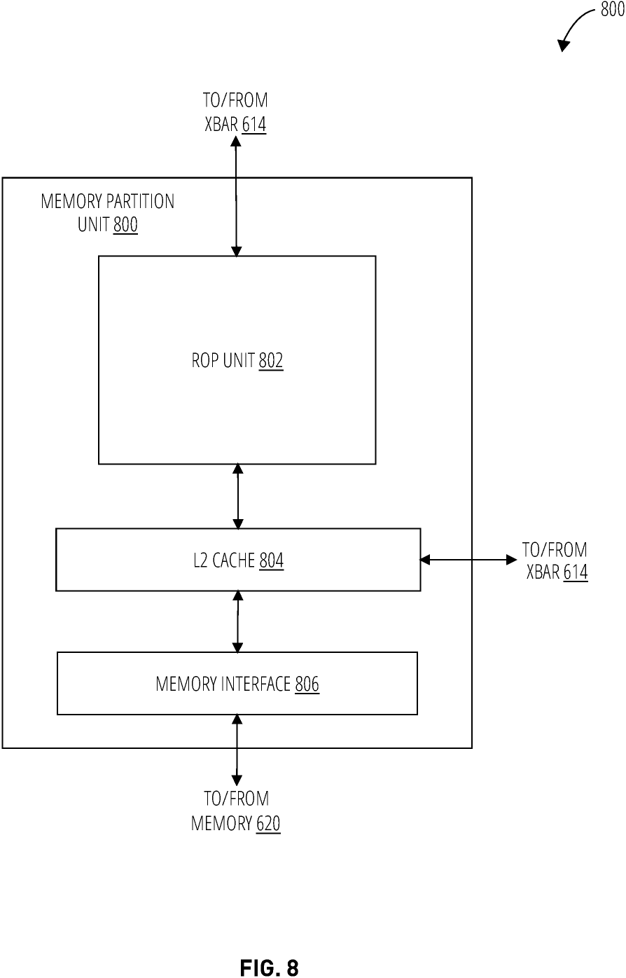

The tasks are managed by the scheduler unit 608 and dispatched to a general processing cluster 700 by the work distribution unit 610. The general processing cluster 700 is configured to process the task and generate results. The results may be consumed by other tasks within the general processing cluster 700, routed to a different general processing cluster 700 via the crossbar 614, or stored in the memory 620. The results can be written to the memory 620 via the memory partition unit 800 modules, which implement a memory interface for reading and writing data to/from the memory 620. The results can be transmitted to another parallel processing unit 602 or CPU via the NVLink 616. In an embodiment, the parallel processing unit 602 includes a number U of memory partition unit 800 modules that is equal to the number of separate and distinct memory 620 devices coupled to the parallel processing unit 602. A memory partition unit 800 will be described in more detail below in conjunction with FIG. 8.

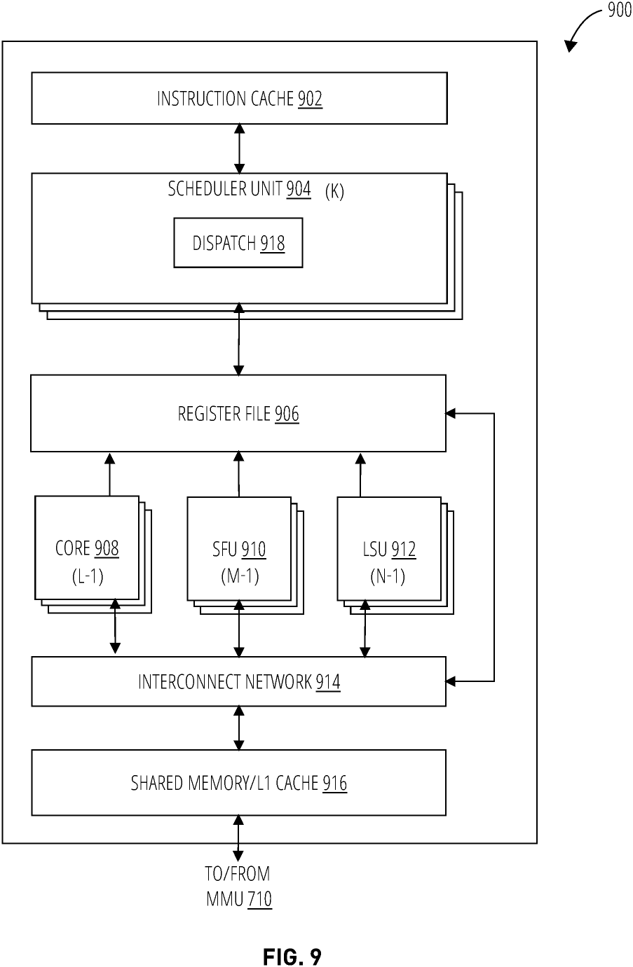

In an embodiment, a host processor executes a driver kernel that implements an application programming interface (API) that enables one or more applications executing on the host processor to schedule operations for execution on the parallel processing unit 602. In an embodiment, multiple compute applications are simultaneously executed by the parallel processing unit 602 and the parallel processing unit 602 provides isolation, quality of service (QoS), and independent address spaces for the multiple compute applications. An application may generate instructions (e.g., API calls) that cause the driver kernel to generate one or more tasks for execution by the parallel processing unit 602. The driver kernel outputs tasks to one or more streams being processed by the parallel processing unit 602. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 9.

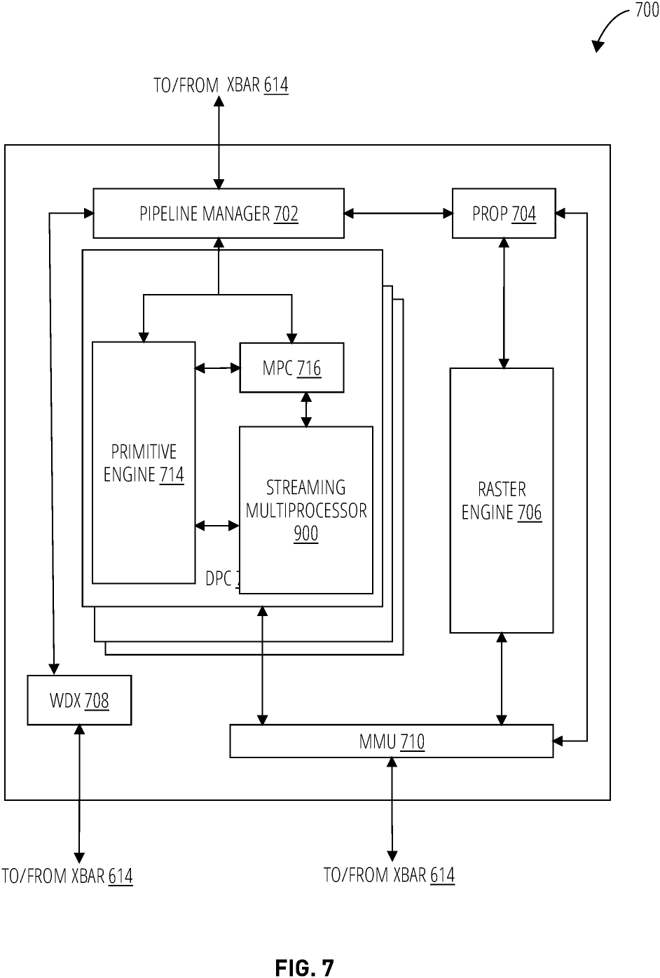

FIG. 7 depicts a general processing cluster 700 of the parallel processing unit 602 of FIG. 6, in accordance with an embodiment. As shown in FIG. 7, each general processing cluster 700 includes a number of hardware units for processing tasks. In an embodiment, each general processing cluster 700 includes a pipeline manager 702, a pre-raster operations unit 704, a raster engine 706, a work distribution crossbar 708, a memory management unit 710, and one or more data processing cluster 712. It will be appreciated that the general processing cluster 700 of FIG. 7 may include other hardware units in lieu of or in addition to the units shown in FIG. 7.

In an embodiment, the operation of the general processing cluster 700 is controlled by the pipeline manager 702. The pipeline manager 702 manages the configuration of the one or more data processing cluster 712 modules for processing tasks allocated to the general processing cluster 700. In an embodiment, the pipeline manager 702 may configure at least one of the one or more data processing cluster 712 modules to implement at least a portion of a graphics rendering pipeline. For example, a data processing cluster 712 may be configured to execute a vertex shader program on the programmable streaming multiprocessor 900. The pipeline manager 702 may also be configured to route packets received from the work distribution unit 610 to the appropriate logical units within the general processing cluster 700. For example, some packets may be routed to fixed function hardware units in the pre-raster operations unit 704 and/or raster engine 706 while other packets may be routed to the data processing cluster 712 modules for processing by the primitive engine 714 or the streaming multiprocessor 900. In an embodiment, the pipeline manager 702 may configure at least one of the one or more data processing cluster 712 modules to implement a neural network model and/or a computing pipeline.

The pre-raster operations unit 704 is configured to route data generated by the raster engine 706 and the data processing cluster 712 modules to a Raster Operations (ROP) unit, described in more detail in conjunction with FIG. 8. The pre-raster operations unit 704 may also be configured to perform optimizations for color blending, organize pixel data, perform address translations, and the like.

The raster engine 706 includes a number of fixed function hardware units configured to perform various raster operations. In an embodiment, the raster engine 706 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 706 comprises fragments to be processed, for example, by a fragment shader implemented within a data processing cluster 712.

Each data processing cluster 712 included in the general processing cluster 700 includes an M-pipe controller 716, a primitive engine 714, and one or more streaming multiprocessor 900 modules. The M-pipe controller 716 controls the operation of the data processing cluster 712, routing packets received from the pipeline manager 702 to the appropriate units in the data processing cluster 712. For example, packets associated with a vertex may be routed to the primitive engine 714, which is configured to fetch vertex attributes associated with the vertex from the memory 620. In contrast, packets associated with a shader program may be transmitted to the streaming multiprocessor 900.

The streaming multiprocessor 900 comprises a programmable streaming processor that is configured to process tasks represented by a number of threads. Each streaming multiprocessor 900 is multi-threaded and configured to execute a plurality of threads (e.g., 32 threads) from a particular group of threads concurrently. In an embodiment, the streaming multiprocessor 900 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 900 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 900 will be described in more detail below in conjunction with FIG. 9.

The memory management unit 710 provides an interface between the general processing cluster 700 and the memory partition unit 800. The memory management unit 710 may provide translation of virtual addresses into physical addresses, memory protection, and arbitration of memory requests. In an embodiment, the memory management unit 710 provides one or more translation lookaside buffers (TLBs) for performing translation of virtual addresses into physical addresses in the memory 620.

FIG. 8 depicts a memory partition unit 800 of the parallel processing unit 602 of FIG. 6, in accordance with an embodiment. As shown in FIG. 8, the memory partition unit 800 includes a raster operations unit 802, a level two cache 804, and a memory interface 806. The memory interface 806 is coupled to the memory 620. Memory interface 806 may implement 32, 64, 128, 1024-bit data buses, or the like, for high-speed data transfer. In an embodiment, the parallel processing unit 602 incorporates U memory interface 806 modules, one memory interface 806 per pair of memory partition unit 800 modules, where each pair of memory partition unit 800 modules is connected to a corresponding memory 620 device. For example, parallel processing unit 602 may be connected to up to Y memory 620 devices, such as high bandwidth memory stacks or graphics double-data-rate, version 5, synchronous dynamic random access memory, or other types of persistent storage.

In an embodiment, the memory interface 806 implements an HBM2 memory interface and Y equals half U. In an embodiment, the HBM2 memory stacks are located on the same physical package as the parallel processing unit 602, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 620 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 602 modules process very large datasets and/or run applications for extended periods.

In an embodiment, the parallel processing unit 602 implements a multi-level memory hierarchy. In an embodiment, the memory partition unit 800 supports a unified memory to provide a single unified virtual address space for CPU and parallel processing unit 602 memory, enabling data sharing between virtual memory systems. In an embodiment the frequency of accesses by a parallel processing unit 602 to memory located on other processors is traced to ensure that memory pages are moved to the physical memory of the parallel processing unit 602 that is accessing the pages more frequently. In an embodiment, the NVLink 616 supports address translation services allowing the parallel processing unit 602 to directly access a CPU’s page tables and providing full access to CPU memory by the parallel processing unit 602.

In an embodiment, copy engines transfer data between multiple parallel processing unit 602 modules or between parallel processing unit 602 modules and CPUs. The copy engines can generate page faults for addresses that are not mapped into the page tables. The memory partition unit 800 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 620 or other system memory may be fetched by the memory partition unit 800 and stored in the level two cache 804, which is located on-chip and is shared between the various general processing cluster 700 modules. As shown, each memory partition unit 800 includes a portion of the level two cache 804 associated with a corresponding memory 620 device. Lower level caches may then be implemented in various units within the general processing cluster 700 modules. For example, each of the streaming multiprocessor 900 modules may implement an L1 cache. The L1 cache is private memory that is dedicated to a particular streaming multiprocessor 900. Data from the level two cache 804 may be fetched and stored in each of the L1 caches for processing in the functional units of the streaming multiprocessor 900 modules. The level two cache 804 is coupled to the memory interface 806 and the crossbar 614.

The raster operations unit 802 performs graphics raster operations related to pixel color, such as color compression, pixel blending, and the like. The raster operations unit 802 also implements depth testing in conjunction with the raster engine 706, receiving a depth for a sample location associated with a pixel fragment from the culling engine of the raster engine 706. The depth is tested against a corresponding depth in a depth buffer for a sample location associated with the fragment. If the fragment passes the depth test for the sample location, then the raster operations unit 802 updates the depth buffer and transmits a result of the depth test to the raster engine 706. It will be appreciated that the number of partition memory partition unit 800 modules may be different than the number of general processing cluster 700 modules and, therefore, each raster operations unit 802 may be coupled to each of the general processing cluster 700 modules. The raster operations unit 802 tracks packets received from the different general processing cluster 700 modules and determines which general processing cluster 700 that a result generated by the raster operations unit 802 is routed to through the crossbar 614. Although the raster operations unit 802 is included within the memory partition unit 800 in FIG. 8, in other embodiment, the raster operations unit 802 may be outside of the memory partition unit 800. For example, the raster operations unit 802 may reside in the general processing cluster 700 or another unit.

FIG. 9 illustrates the streaming multiprocessor 900 of FIG. 7, in accordance with an embodiment. As shown in FIG. 9, the streaming multiprocessor 900 includes an instruction cache 902, one or more scheduler unit 904 modules (e.g., such as scheduler unit 608), a register file 906 (which may implement the register pools described herein), one or more processing core 908 modules, one or more special function unit 910 modules, one or more load/store unit 912 modules, an interconnect network 914, and a shared memory/L1 cache 916.

As described above, the work distribution unit 610 dispatches tasks for execution on the general processing cluster 700 modules of the parallel processing unit 602. The tasks are allocated to a particular data processing cluster 712 within a general processing cluster 700 and, if the task is associated with a shader program, the task may be allocated to a streaming multiprocessor 900. The scheduler unit 608 receives the tasks from the work distribution unit 610 and manages instruction scheduling for one or more thread blocks assigned to the streaming multiprocessor 900. The scheduler unit 904 schedules thread blocks for execution as warps of parallel threads, where each thread block is allocated at least one warp. In an embodiment, each warp executes 32 threads. The scheduler unit 904 may manage a plurality of different thread blocks, allocating the warps to the different thread blocks and then dispatching instructions from the plurality of different cooperative groups to the various functional units (e.g., core 908 modules, special function unit 910 modules, and load/store unit 912 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads() function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 918 unit is configured within the scheduler unit 904 to transmit instructions to one or more of the functional units. In one embodiment, the scheduler unit 904 includes two dispatch 918 units that enable two different instructions from the same warp to be dispatched during each clock cycle. In alternative embodiments, each scheduler unit 904 may include a single dispatch 918 unit or additional dispatch 918 units.

Each streaming multiprocessor 900 includes a register file 906 that provides a set of registers for the functional units of the streaming multiprocessor 900. In an embodiment, the register file 906 is divided between each of the functional units such that each functional unit is allocated a dedicated portion of the register file 906. In another embodiment, the register file 906 is divided between the different warps being executed by the streaming multiprocessor 900. The register file 906 provides temporary storage for operands connected to the data paths of the functional units.

Each streaming multiprocessor 900 comprises L processing core 908 modules. In an embodiment, the streaming multiprocessor 900 includes a large number (e.g., 128, etc.) of distinct processing core 908 modules. Each core 908 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 908 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 908 modules. In particular, the tensor cores are configured to perform deep learning matrix arithmetic, such as convolution operations for neural network training and inferencing. In an embodiment, each tensor core operates on a 4x4 matrix and performs a matrix multiply and accumulate operation D=A'B+C, where A, B, C, and D are 4x4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4x4x4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16x16 size matrices spanning all 32 threads of the warp.

Each streaming multiprocessor 900 also comprises M special function unit 910 modules that perform special functions (e.g., attribute evaluation, reciprocal square root, and the like). In an embodiment, the special function unit 910 modules may include a tree traversal unit configured to traverse a hierarchical tree data structure. In an embodiment, the special function unit 910 modules may include texture unit configured to perform texture map filtering operations. In an embodiment, the texture units are configured to load texture maps (e.g., a 2D array of texels) from the memory 620 and sample the texture maps to produce sampled texture values for use in shader programs executed by the streaming multiprocessor 900. In an embodiment, the texture maps are stored in the shared memory/L1 cache 916. The texture units implement texture operations such as filtering operations using mip-maps (e.g., texture maps of varying levels of detail). In an embodiment, each streaming multiprocessor 900 includes two texture units.

Each streaming multiprocessor 900 also comprises N load/store unit 912 modules that implement load and store operations between the shared memory/L1 cache 916 and the register file 906. Each streaming multiprocessor 900 includes an interconnect network 914 that connects each of the functional units to the register file 906 and the load/store unit 912 to the register file 906 and shared memory/L1 cache 916. In an embodiment, the interconnect network 914 is a crossbar that can be configured to connect any of the functional units to any of the registers in the register file 906 and connect the load/store unit 912 modules to the register file 906 and memory locations in shared memory/L1 cache 916.

The shared memory/L1 cache 916 is an array of on-chip memory that allows for data storage and communication between the streaming multiprocessor 900 and the primitive engine 714 and between threads in the streaming multiprocessor 900. In an embodiment, the shared memory/L1 cache 916 comprises 128 KB of storage capacity and is in the path from the streaming multiprocessor 900 to the memory partition unit 800. The shared memory/L1 cache 916 can be used to cache reads and writes. One or more of the shared memory/L1 cache 916, level two cache 804, and memory 620 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 916 enables the shared memory/L1 cache 916 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 6, are bypassed, creating a much simpler programming model. In the general purpose parallel computation configuration, the work distribution unit 610 assigns and distributes blocks of threads directly to the data processing cluster 712 modules. The threads in a block execute the same program, using a unique thread ID in the calculation to ensure each thread generates unique results, using the streaming multiprocessor 900 to execute the program and perform calculations, shared memory/L1 cache 916 to communicate between threads, and the load/store unit 912 to read and write global memory through the shared memory/L1 cache 916 and the memory partition unit 800. When configured for general purpose parallel computation, the streaming multiprocessor 900 can also write commands that the scheduler unit 608 can use to launch new work on the data processing cluster 712 modules.

The parallel processing unit 602 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 602 is embodied on a single semiconductor substrate. In another embodiment, the parallel processing unit 602 is included in a system-on-a-chip (SoC) along with one or more other devices such as additional parallel processing unit 602 modules, the memory 620, a reduced instruction set computer (RISC) CPU, a memory management unit (MMU), a digital-to-analog converter (DAC), and the like.

In an embodiment, the parallel processing unit 602 may be included on a graphics card that includes one or more memory devices. The graphics card may be configured to interface with a PCIe slot on a motherboard of a desktop computer. In yet another embodiment, the parallel processing unit 602 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 10 is a conceptual diagram of a processing system 1000 implemented using the parallel processing unit 602 of FIG. 6, in accordance with an embodiment. The processing system 1000 includes a central processing unit 1002, switch 1004, and multiple parallel processing unit 602 modules each and respective memory 620 modules. The NVLink 616 provides high-speed communication links between each of the parallel processing unit 602 modules. Although a particular number of NVLink 616 and interconnect 618 connections are illustrated in FIG. 10, the number of connections to each parallel processing unit 602 and the central processing unit 1002 may vary. The switch 1004 interfaces between the interconnect 618 and the central processing unit 1002. The parallel processing unit 602 modules, memory 620 modules, and NVLink 616 connections may be situated on a single semiconductor platform to form a parallel processing module 1006. In an embodiment, the switch 1004 supports two or more protocols to interface between various different connections and/or links.

In another embodiment (not shown), the NVLink 616 provides one or more high-speed communication links between each of the parallel processing unit modules (parallel processing unit 602, parallel processing unit 602, parallel processing unit 602, and parallel processing unit 602) and the central processing unit 1002 and the switch 1004 interfaces between the interconnect 618 and each of the parallel processing unit modules. The parallel processing unit modules, memory 620 modules, and interconnect 618 may be situated on a single semiconductor platform to form a parallel processing module 1006. In yet another embodiment (not shown), the interconnect 618 provides one or more communication links between each of the parallel processing unit modules and the central processing unit 1002 and the switch 1004 interfaces between each of the parallel processing unit modules using the NVLink 616 to provide one or more high-speed communication links between the parallel processing unit modules. In another embodiment (not shown), the NVLink 616 provides one or more high-speed communication links between the parallel processing unit modules and the central processing unit 1002 through the switch 1004. In yet another embodiment (not shown), the interconnect 618 provides one or more communication links between each of the parallel processing unit modules directly. One or more of the NVLink 616 high-speed communication links may be implemented as a physical NVLink interconnect or either an on-chip or on-die interconnect using the same protocol as the NVLink 616.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1006 may be implemented as a circuit board substrate and each of the parallel processing unit modules and/or memory 620 modules may be packaged devices. In an embodiment, the central processing unit 1002, switch 1004, and the parallel processing module 1006 are situated on a single semiconductor platform.

In an embodiment, the signaling rate of each NVLink 616 is 20 to 25 Gigabits/second and each parallel processing unit module includes six NVLink 616 interfaces (as shown in FIG. 10, five NVLink 616 interfaces are included for each parallel processing unit module). Each NVLink 616 provides a data transfer rate of 25 Gigabytes/second in each direction, with six links providing 300 Gigabytes/second. The NVLink 616 can be used exclusively for PPU-to-PPU communication as shown in FIG. 10, or some combination of PPU-to-PPU and PPU-to-CPU, when the central processing unit 1002 also includes one or more NVLink 616 interfaces.

In an embodiment, the NVLink 616 allows direct load/store/atomic access from the central processing unit 1002 to each parallel processing unit module’s memory 620. In an embodiment, the NVLink 616 supports coherency operations, allowing data read from the memory 620 modules to be stored in the cache hierarchy of the central processing unit 1002, reducing cache access latency for the central processing unit 1002. In an embodiment, the NVLink 616 includes support for Address Translation Services (ATS), enabling the parallel processing unit module to directly access page tables within the central processing unit 1002. One or more of the NVLink 616 may also be configured to operate in a low-power mode.

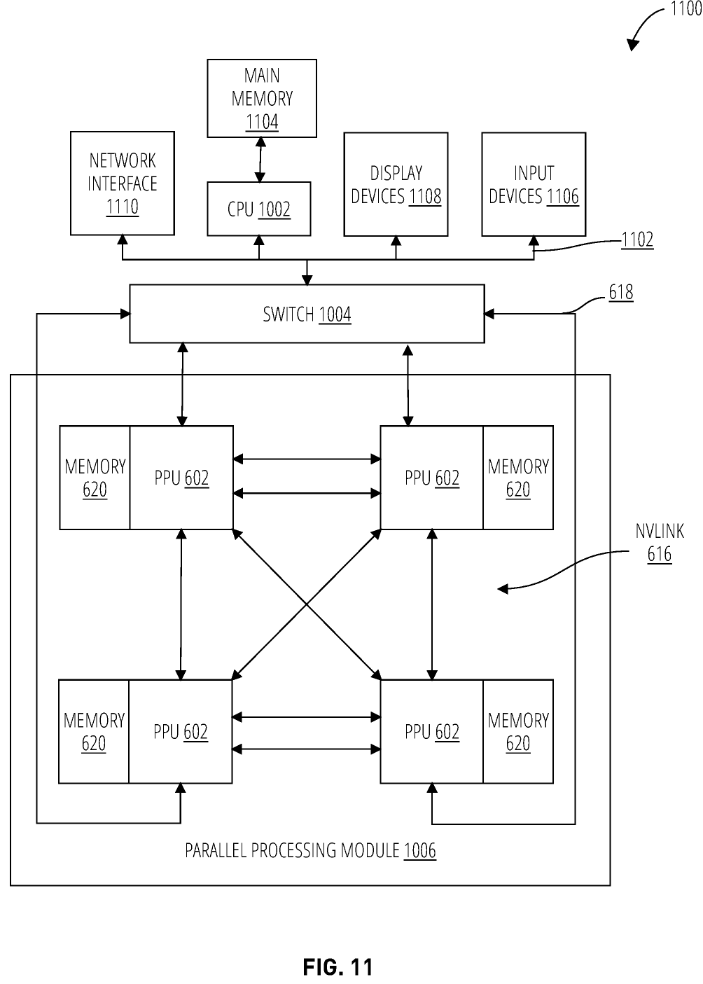

FIG. 11 depicts an exemplary processing system 1100 in which the various architecture and/or functionality of the various previous embodiments may be implemented. As shown, an exemplary processing system 1100 is provided including at least one central processing unit 1002 that is connected to a communications bus 1102. The communication communications bus 1102 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1100 also includes a main memory 1104. Control logic (software) and data are stored in the main memory 1104 which may take the form of random access memory (RAM).

The exemplary processing system 1100 also includes input devices 1106, the parallel processing module 1006, and display devices 1108, e.g. a conventional CRT (cathode ray tube), LCD (liquid crystal display), LED (light emitting diode), plasma display or the like. User input may be received from the input devices 1106, e.g., keyboard, mouse, touchpad, microphone, and the like. Each of the foregoing modules and/or devices may even be situated on a single semiconductor platform to form the exemplary processing system 1100. Alternately, the various modules may also be situated separately or in various combinations of semiconductor platforms per the desires of the user.

Further, the exemplary processing system 1100 may be coupled to a network (e.g., a telecommunications network, local area network (LAN), wireless network, wide area network (WAN) such as the Internet, peer-to-peer network, cable network, or the like) through a network interface 1110 for communication purposes.

The exemplary processing system 1100 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1104 and/or the secondary storage. Such computer programs, when executed, enable the exemplary processing system 1100 to perform various functions. The main memory 1104, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1100 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

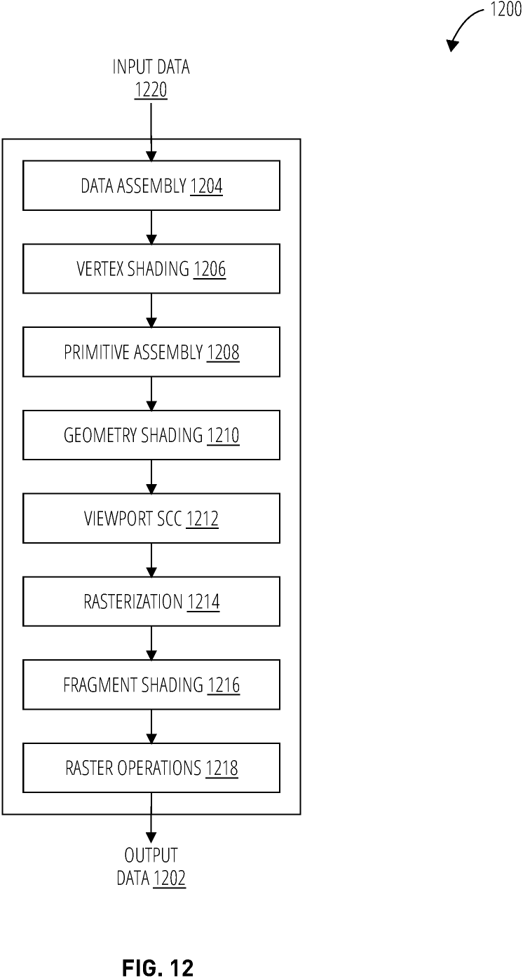

FIG. 12 is a conceptual diagram of a graphics processing pipeline 1200 implemented by the parallel processing unit 602 of FIG. 6, in accordance with an embodiment. In an embodiment, the parallel processing unit 602 comprises a graphics processing unit (GPU). The parallel processing unit 602 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 602 can be configured to process the graphics primitives to generate a frame buffer (e.g., pixel data for each of the pixels of the display).

An application writes model data for a scene (e.g., a collection of vertices and attributes) to a memory such as a system memory or memory 620. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 900 modules of the parallel processing unit 602 including one or more of a vertex shader, hull shader, domain shader, geometry shader, and a pixel shader. For example, one or more of the streaming multiprocessor 900 modules may be configured to execute a vertex shader program that processes a number of vertices defined by the model data. In an embodiment, the different streaming multiprocessor 900 modules may be configured to execute different shader programs concurrently. For example, a first subset of streaming multiprocessor 900 modules may be configured to execute a vertex shader program while a second subset of streaming multiprocessor 900 modules may be configured to execute a pixel shader program. The first subset of streaming multiprocessor 900 modules processes vertex data to produce processed vertex data and writes the processed vertex data to the level two cache 804 and/or the memory 620. After the processed vertex data is rasterized (e.g., transformed from three-dimensional data into two-dimensional data in screen space) to produce fragment data, the second subset of streaming multiprocessor 900 modules executes a pixel shader to produce processed fragment data, which is then blended with other processed fragment data and written to the frame buffer in memory 620. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 1200 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 1200 receives input data 601 that is transmitted from one stage to the next stage of the graphics processing pipeline 1200 to generate output data 1202. In an embodiment, the graphics processing pipeline 1200 may represent a graphics processing pipeline defined by the OpenGL® API. As an option, the graphics processing pipeline 1200 may be implemented in the context of the functionality and architecture of the previous Figures and/or any subsequent Figure(s).

As shown in FIG. 12, the graphics processing pipeline 1200 comprises a pipeline architecture that includes a number of stages. The stages include, but are not limited to, a data assembly 1204 stage, a vertex shading 1206 stage, a primitive assembly 1208 stage, a geometry shading 1210 stage, a viewport SCC 1212 stage, a rasterization 1214 stage, a fragment shading 1216 stage, and a raster operations 1218 stage. In an embodiment, the input data 1220 comprises commands that configure the processing units to implement the stages of the graphics processing pipeline 1200 and geometric primitives (e.g., points, lines, triangles, quads, triangle strips or fans, etc.) to be processed by the stages. The output data 1202 may comprise pixel data (e.g., color data) that is copied into a frame buffer or other type of surface data structure in a memory.

The data assembly 1204 stage receives the input data 1220 that specifies vertex data for high-order surfaces, primitives, or the like. The data assembly 1204 stage collects the vertex data in a temporary storage or queue, such as by receiving a command from the host processor that includes a pointer to a buffer in memory and reading the vertex data from the buffer. The vertex data is then transmitted to the vertex shading 1206 stage for processing.

The vertex shading 1206 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1206 stage may manipulate individual vertex attributes such as position, color, texture coordinates, and the like. In other words, the vertex shading 1206 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1206 stage generates transformed vertex data that is transmitted to the primitive assembly 1208 stage.

The primitive assembly 1208 stage collects vertices output by the vertex shading 1206 stage and groups the vertices into geometric primitives for processing by the geometry shading 1210 stage. For example, the primitive assembly 1208 stage may be configured to group every three consecutive vertices as a geometric primitive (e.g., a triangle) for transmission to the geometry shading 1210 stage. In some embodiments, specific vertices may be reused for consecutive geometric primitives (e.g., two consecutive triangles in a triangle strip may share two vertices). The primitive assembly 1208 stage transmits geometric primitives (e.g., a collection of associated vertices) to the geometry shading 1210 stage.

The geometry shading 1210 stage processes geometric primitives by performing a set of operations (e.g., a geometry shader or program) on the geometric primitives. Tessellation operations may generate one or more geometric primitives from each geometric primitive. In other words, the geometry shading 1210 stage may subdivide each geometric primitive into a finer mesh of two or more geometric primitives for processing by the rest of the graphics processing pipeline 1200. The geometry shading 1210 stage transmits geometric primitives to the viewport SCC 1212 stage.

In an embodiment, the graphics processing pipeline 1200 may operate within a streaming multiprocessor and the vertex shading 1206 stage, the primitive assembly 1208 stage, the geometry shading 1210 stage, the fragment shading 1216 stage, and/or hardware/software associated therewith, may sequentially perform processing operations. Once the sequential processing operations are complete, in an embodiment, the viewport SCC 1212 stage may utilize the data. In an embodiment, primitive data processed by one or more of the stages in the graphics processing pipeline 1200 may be written to a cache (e.g. L1 cache, a vertex cache, etc.). In this case, in an embodiment, the viewport SCC 1212 stage may access the data in the cache. In an embodiment, the viewport SCC 1212 stage and the rasterization 1214 stage are implemented as fixed function circuitry.

The viewport SCC 1212 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1214 stage.

The rasterization 1214 stage converts the 3D geometric primitives into 2D fragments (e.g. capable of being utilized for display, etc.). The rasterization 1214 stage may be configured to utilize the vertices of the geometric primitives to setup a set of plane equations from which various attributes can be interpolated. The rasterization 1214 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1214 stage generates fragment data (e.g., interpolated vertex attributes associated with a particular sample location for each covered pixel) that are transmitted to the fragment shading 1216 stage.

The fragment shading 1216 stage processes fragment data by performing a set of operations (e.g., a fragment shader or a program) on each of the fragments. The fragment shading 1216 stage may generate pixel data (e.g., color values) for the fragment such as by performing lighting operations or sampling texture maps using interpolated texture coordinates for the fragment. The fragment shading 1216 stage generates pixel data that is transmitted to the raster operations 1218 stage.

The raster operations 1218 stage may perform various operations on the pixel data such as performing alpha tests, stencil tests, and blending the pixel data with other pixel data corresponding to other fragments associated with the pixel. When the raster operations 1218 stage has finished processing the pixel data (e.g., the output data 1202), the pixel data may be written to a render target such as a frame buffer, a color buffer, or the like.

It will be appreciated that one or more additional stages may be included in the graphics processing pipeline 1200 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1210 stage). Other types of graphics processing pipelines are contemplated as being within the scope of the present disclosure. Furthermore, any of the stages of the graphics processing pipeline 1200 may be implemented by one or more dedicated hardware units within a graphics processor such as parallel processing unit 602. Other stages of the graphics processing pipeline 1200 may be implemented by programmable hardware units such as the streaming multiprocessor 900 of the parallel processing unit 602.

The graphics processing pipeline 1200 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 602. The API provides an abstraction for a programmer that lets a programmer utilize specialized graphics hardware, such as the parallel processing unit 602, to generate the graphical data without requiring the programmer to utilize the specific instruction set for the parallel processing unit 602. The application may include an API call that is routed to the device driver for the parallel processing unit 602. The device driver interprets the API call and performs various operations to respond to the API call. In some instances, the device driver may perform operations by executing instructions on the CPU. In other instances, the device driver may perform operations, at least in part, by launching operations on the parallel processing unit 602 utilizing an input/output interface between the CPU and the parallel processing unit 602. In an embodiment, the device driver is configured to implement the graphics processing pipeline 1200 utilizing the hardware of the parallel processing unit 602.

Various programs may be executed within the parallel processing unit 602 in order to implement the various stages of the graphics processing pipeline 1200. For example, the device driver may launch a kernel on the parallel processing unit 602 to perform the vertex shading 1206 stage on one streaming multiprocessor 900 (or multiple streaming multiprocessor 900 modules). The device driver (or the initial kernel executed by the parallel processing unit 602) may also launch other kernels on the parallel processing unit 602 to perform other stages of the graphics processing pipeline 1200, such as the geometry shading 1210 stage and the fragment shading 1216 stage. In addition, some of the stages of the graphics processing pipeline 1200 may be implemented on fixed unit hardware such as a rasterizer or a data assembler implemented within the parallel processing unit 602. It will be appreciated that results from one kernel may be processed by one or more intervening fixed function hardware units before being processed by a subsequent kernel on a streaming multiprocessor 900.

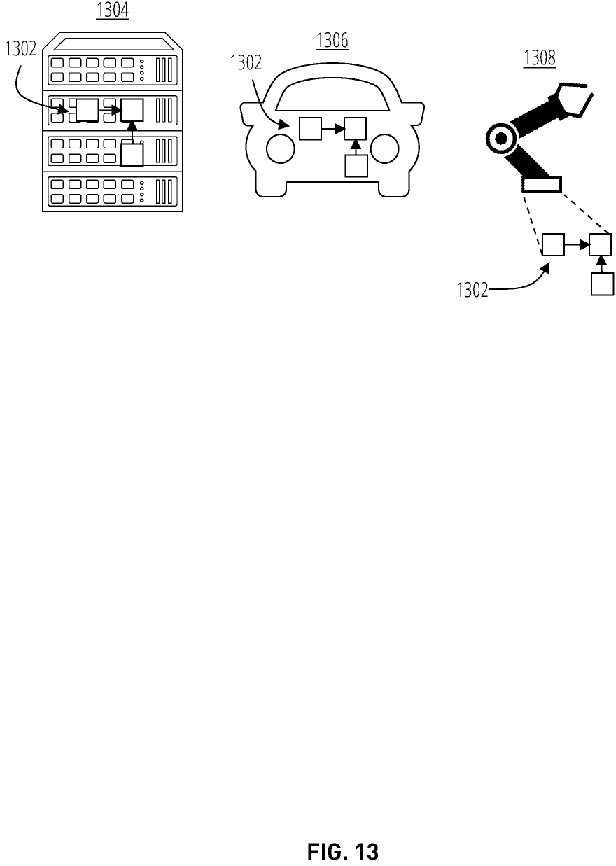

FIG. 13 depicts exemplary scenarios for use of a computing platform 1302 in accordance with some embodiments. A computing platform 1302 may be utilized in a computing system 1304, a vehicle 1306, and a robot 1308, to name just a few examples. The computing platform 1302 may comprise a one or more processors (such as GPUs), memories, and register files, for example.

### Listing of Drawing Elements

102 kernel
104 shader 1
106 shader 2
108 shader N
110 convergence point
200 shard divergence
202 application code
204 warp
206 thread divergence
208 shard
210 shard
212 warp sharding
214 thread reconvergence
402 register file
404 inter-block reuse pool
406 intra-block reuse pool
408 per-thread allocated registers
502 allocated state
504 inter-block reserved state
506 intra-block reserved state
508 free state
602 parallel processing unit
604 I/O unit
606 front-end unit
608 scheduler unit
610 work distribution unit
612 hub
614 crossbar
616 NVLink
618 interconnect
620 memory
700 general processing cluster
702 pipeline manager
704 pre-raster operations unit
706 raster engine
708 work distribution crossbar
710 memory management unit
712 data processing cluster
714 primitive engine
716 M-pipe controller
800 memory partition unit
802 raster operations unit
804 level two cache
806 memory interface
900 streaming multiprocessor
902 instruction cache
904 scheduler unit
906 register file
908 core
910 special function unit
912 load/store unit
914 interconnect network
916 shared memory/L1 cache
918 dispatch
1000 processing system
1002 central processing unit
1004 switch
1006 parallel processing module
1100 exemplary processing system
1102 communications bus
1104 main memory
1106 input devices
1108 display devices
1110 network interface
1200 graphics processing pipeline
1202 output data 1204 data assembly
1206 vertex shading
1208 primitive assembly
1210 geometry shading
1212 viewport SCC
1214 rasterization
1216 fragment shading
1218 raster operations
1220 input data
1302 computing platform
1304 computing system
1306 vehicle
1308 robot

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A system comprising:
a processor;
a memory comprising application code that configures the processor to execute an application; and
logic to generate register acquire instructions and register release instructions in the application code, such that when executed by the processor, the application code borrows and returns registers to an inter-block register pool when execution enters a particular section of the application code.

2. The system of claim 1, further comprising:
logic to generate in the application code a slow execution path that employs register spill and refill instructions to be executed only on condition that the register acquire instructions fail.

3. The system of claim 2, further comprising:
logic to determine a register launch target for the application code based on register utilization in the slow execution path.

4. The system of claim 3, the register launch target determined by runtime profiling of the application code.

5. The system of claim 1, further comprising:
logic to identify register utilization in sections of the application code using one or both of static analysis and runtime profile analysis of the application code.

6. The system of claim 1, further comprising:
logic to identify and configure a minimum register target for the application code below which the application code is configured to not release registers.

7. The system of claim 1, further comprising:
logic to generate in the application code a back-off loop that re-attempts the register acquire instructions on condition that the inter-block register pool is empty or fails to satisfy a configured threshold level.

8. The system of claim 1, further comprising:
logic to generate in the application code a plurality of slow execution paths that each implement a different extent of register spill and refill.

9. The system of claim 1, further comprising:
a free register pool;
an intra-block register pool;
an inter-block register pool;
logic to configure some of the register acquire instructions and register release instructions in the application code to borrow registers from and return registers to the intra-block register pool exclusively for threads in a same thread block; and
logic to cause some of the register acquire instructions and register release instructions in the application code to borrow from and return registers to the inter-block register pool exclusively for thread blocks belonging to the inter-block register pool.

10. A system comprising:
a processor;
a memory comprising application code that configures the processor to execute an application;
logic to insert register acquire instructions into the application code; and
logic to generate in the application code a slow execution path that employs register spill and refill instructions and is only executed on condition that the register acquire instructions fail.

11. The system of claim 10, further comprising:
an inter-block register pool; and
logic to configure the register acquire instructions in the application code to borrow from the inter-block register pool exclusively for thread blocks belonging to the inter-block register pool.

12. A method comprising:
inserting register acquire instructions and register release instructions for an inter-block register pool into a first section of application code; and
launching execution of the application code with a register allocation based on register utilization of a second section of the application code that employs register spill and refill instructions.

13. The method of claim 12, further comprising:
executing the second section of the application code that employs register spill and refill instructions on condition that the register acquire instructions fail.

14. The method of claim 12, further comprising:
identifying high register utilization and low register utilization regions of the application code from one or both of static analysis and runtime profile analysis of the application code.

15. The method of claim 14, further comprising:
inserting the register acquire instructions and register release instructions into the high register utilization region but not into the low register utilization region.

16. The method of claim 12, the register allocation determined by runtime profiling of the application code.

17. The method of claim 12, further comprising:
configuring a minimum register target for the application code below which the application code is configured to not release registers.

18. The method of claim 12,
inserting into the application code a back-off loop that re-attempts the register acquire instructions on condition that the inter-block register pool is empty or fails to satisfy a configured threshold level.

19. The method of claim 12, further comprising:
generating in the application code a plurality of slow execution versions of the application code that implement among them a spectrum of register spill and refill instructions.

20. The method of claim 12, further comprising:
configuring some of the register acquire instructions and register release instructions in the application code to borrow registers from and return registers to an intra-block register pool exclusively for threads in a same thread block; and
configuring some of the register acquire instructions and register release instructions in the application code to borrow from and return registers to the inter-block register pool exclusively for thread blocks belonging to the inter-block register pool.
